(19) United States
(12) Patent Application Publication
(10) Pub. No.: US 2023/0086372 A1
(43) Pub. Date: Mar. 23, 2023

(54) ESTIMATING MEDIA LEVELS USING REGRESSIONS

(71) Applicant: HEWLETT-PACKARD DEVELOPMENT COMPANY, L.P., Spring, TX (US)

(72) Inventors: Peter James Boucher, Vancouver, WA (US); Peter James Boucher, JR., Vancouver, WA (US); Eric Scott Collins, Vancouver, WA (US); Roseann Lok Sum Chan, Vancouver, WA (US)

(21) Appl. No.: 17/481,561

(22) Filed: Sep. 22, 2021

(51) Int. Cl. G06F 3/12; B41J 13/10

(52) U.S. Cl. CPC G06F 3/121; G06F 3/1229; B41J 13/106; G06F 2206/1506

(57) ABSTRACT

An example method for estimating a media level of a media stack in a printer includes storing a media level model correlating a picker metric of a media picker to pick media from the media stack to the media level; measuring a current picker metric when the media picker picks the media from the media stack during a print job; adding the current picker metric to a historical data set; updating the media level model by generating a regression for the historical data set; and based on the current picker metric and the updated media level model, estimating a current media level of the media stack.

### BACKGROUND

Printers have media trays which store media sheets for use during printer operations. The media trays can store a finite number of media sheets. Some printers may estimate the media level of the media tray to track the usage of the media in the printer.

### BRIEF DESCRIPTION OF THE DRAWINGS

FIG. 1 is a flowchart of an example method of estimating media levels of a media stack in a printer using regression.

FIG. 2 is a block diagram of an example printer which estimates media levels using regression.

FIGS. 3A and 3B are block diagrams of an example media picker picking a sheet from a high stack and a low stack of media sheets, respectively, in the printer of FIG. 2.

FIG. 4 is a flowchart of another example method of estimating media levels of a media stack using regression.

FIG. 5 is a flowchart of an example method of estimating a number of sheets remaining at block 410 of FIG. 4.

### DETAILED DESCRIPTION

Printers which estimate the media level of the media tray often use predefined relationships between measured metrics and media levels to estimate the media level. However, such methods assume that the relationship between the measured metrics and the media levels are consistent and that the measured metrics are reliably determined. This may not be the case, for example if different types of media are used, which have different thicknesses, or if the measured metrics are incorrect for a given measurement.

An example printer estimates the media level in a media tray dynamically using regressions. During each print job, a picker metric is tracked and added to a historical data set. The historical data set, together with the total number of pages picked, may be used to generate a regression, such as a linear regression, which more accurately models the relationship between the picker metric and the pages used. The regression may be used to update a media level model, which in turn may be used to estimate the current media level. Thus, the media level model is based on actual usage data and may be updated and adjusted to account for different types of media. Further, the historical data set may be processed to remove outliers to obtain a more accurate media level model. The historical data set may be reset or cleared when the media tray is opened.

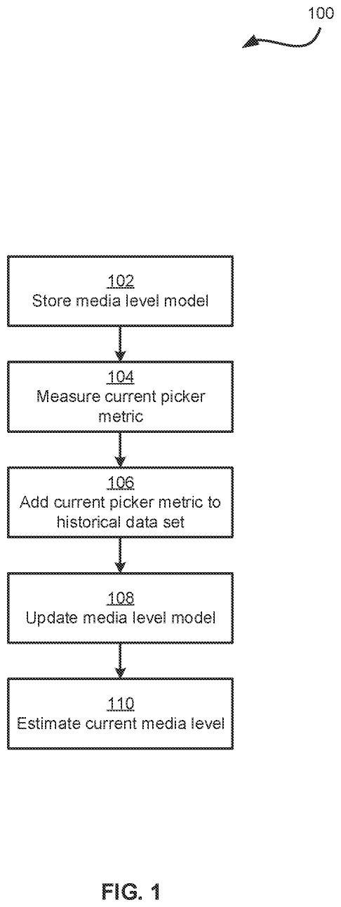

FIG. 1 shows a flowchart of an example method 100 of estimating a media level of a media stack in a printer. In particular, the method 100 employs regressions to estimate the media level and dynamically updates its model of the media level. The method 100 may be executed, for example by a controller of the printer, or other suitable processor or computing device.

At block 102, the printer stores a media level model correlating a picker metric of a media picker to the media level.

In particular, the printer includes the media picker to pick media from the media stack for a print job. The media picker may include a roller, a pick arm, a lift rack, a wedge and cam follower, combinations of the above, and/or other suitable components to allow the media picker to pick media from the media stack for a print job. The printer may further include a sensor or sensing system to measure a picker metric associated with a given operation of the media picker. The sensor may be a stand-alone sensor, employing optical (e.g., laser, LIDAR, or the like) techniques to obtain the picker metric, or other suitable techniques. In other examples, the sensing system may be integrated with the existing printer components, for example by tracking an amount of torque used by a motor of the lift rack to drive the lift rack to lift the pick arm.

The picker metric may therefore be any suitable metric associated with the media picker which is correlated to the media level, such that as the media level changes, the picker metric also changes according to a known, predictable relationship. For example, the picker metric may be a position at which a peak amount of torque is used to lift the pick arm. In such examples, the amount of torque changes based on the height of the media stack. The media level model therefore correlates the picker metric to the media level according to the known, predictable relationship. That is, the media level model may map the picker metric as a function of the media level. The media level model stored initially may be a predefined default model generated based on the known relationship and certain default assumptions about the media itself (e.g., a thickness of each media sheet).

The media level may be any suitable metric which tracks the amount of media remaining in the media stack. For example, the media level may be a number of media sheets remaining in the media stack. In other examples, the media level may be a height of the media stack.

At block 104, the printer measures a current picker metric when the media picker picks the media from the media stack during a print job. That is, when a print job is underway, the media picker picks at least one sheet of media from the media stack. The picker metric measured during that instance of picking the media is tracked as the current picker metric. In some examples, the picker metric may be measured once per print job, while in other examples, the picker metric may be measured each time the media picker picks a media sheet (i.e., multiple times per print jobs using multiple media sheets).

At block 106, the printer adds the current picker metric measured at block 104 to a historical data set. The historical data set may be stored, for example, in a memory of the printer. The historical data set tracks the picker metrics measured at each print job and/or at each instance that the media picker picks media from the media stack. The historical data set may include the picker metric, a number of sheets picked since the last picker metric was obtained, as well as other relevant data.

At block 108, the printer updates the media level model by generating a regression for the historical data set. That is, the printer applies a regression analysis to the historical data set to find the function that best fits the historical data set. For example, the printer may apply a linear regression to generate a linear model of the media level. The linear model may represent the picker metric as a linear function of the media level. In other examples, other types of functions may be possible for the model. The media level model is updated based on the function obtained from the regression analysis. In order to generate a more accurate media level model, the regression or model may be calibrated based on a predefined height for an empty media stack. That is, the model may be shifted such that the estimated media level according to the media level model corresponds to an empty media stack at a predefined height based on known parameters of the printer.

In this manner, the media level model is dynamically updated based on data obtained over time during use of the printer and the media picker. The media level model may thus be calibrated based on potentially changing variables, such as the thickness of each media sheet.

At block 110, the printer estimates a current media level of the media stack based on the current picker metric obtained at block 104 and the updated media level model obtained at block 108. That is, the printer may input the current picker metric into the function defining the updated media level model to compute the current media level. The current media level may be expressed as a height of the media stack, a number of sheets remaining in the media stack, or the like. In some examples, when the current media level of the media stack is below a threshold value, the printer may output a notification. Thus, it may be useful to track a number of sheets remaining in the media stack to notify a user that the media stack should be refilled, since the stack height may be unreliable depending on the thickness of the media sheets.

Thus, the method 100 provides printers with the capability to track the media level of media trays dynamically using regressions to improve the accuracy of the estimate based on actual data use. The historical data set may be cleared and reset when the printer detects that the media tray is opened, since the media may be refilled, taken out and replaced with different type of media, and the like.

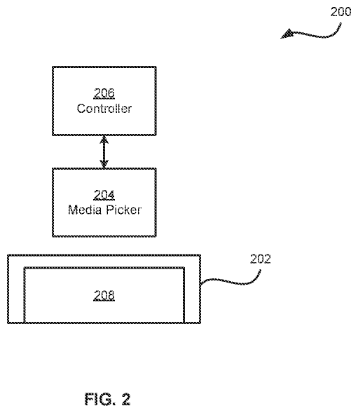

FIG. 2 depicts a block diagram of an example printer 200 which estimates media levels using regressions. The printer 200 includes a media tray 202, a media picker 204, and a controller 206 interconnected with the media picker 204.

The media tray 202 is to store a stack 208 of media sheets for use in the printer 200. For example, the media sheets may be sheets of varying sizes, types, or thicknesses, including cardstock, paper, brochure or photo paper, and the like. The stack 208 stored in the media tray 202 has a certain height based on the amount of media remaining in the stack 208. To facilitate the user experience and reduce instances of a no media warning, the printer 200 may estimate the media level of the stack 208 and warn the user when the media level of the stack 208 is low, rather than when it is empty.

The media picker 204 is to pick the media sheets from the stack 208 during a print job. The media picker 204 may include components such as, but not limited to, a roller, a pick arm, a lift rack, a wedge and cam follower, and the like. The media picker 204 is associated with a picker metric which measures a performance aspect of the media picker 204. The picker metric is further correlated to the media level, such that as the media level changes, the picker metric also changes. In particular, the picker metric and the media level may be correlated according to a predetermined relationship. For example, the picker metric and the media level may have a linear relationship.

The controller 206 is interconnected with the media picker 204 to control the media picker 204. In particular, the controller 206 is to control the media picker 204 to pick the media sheets from the stack 208 for a print job and measure a current picker metric for the media picker 204.

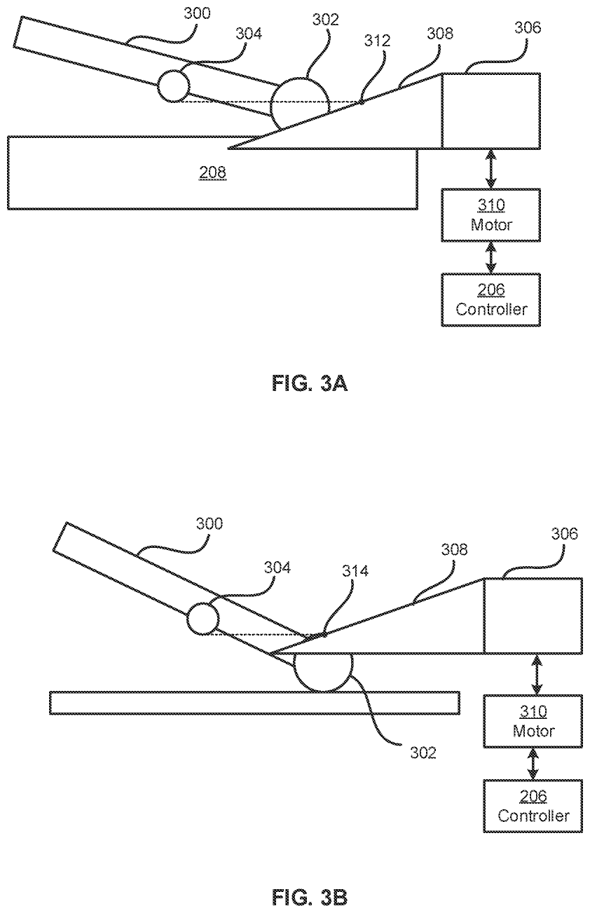

For example, referring to FIGS. 3A and 3B, an example media picker 204 is depicted. The media picker 204 includes a pick arm 300 including a roller 302 to contact the top sheet of the stack 208 of media sheets. The media picker 204 further includes a cam follower 304 extending from the pick arm. The media picker 204 further includes a lift rack 306 including a wedge 308 extending from the lift rack 306 towards the cam follower 304. The lift rack 306 is driven by a motor 310 controlled by the controller 206.

The lift rack 306 and the pick arm 300 are oriented such that the wedge 308 faces towards the pick arm 300 and is aligned with the cam follower 304. In operation, to pick a media sheet, the controller 206 controls the pick arm 300 to be lowered until the roller 302 contacts the top media sheet of the stack 208. The roller 302 is then rotated to push the top media sheet from the stack. After an appropriate number of media sheets have been picked, in accordance with the print job, the controller 206 controls the motor 310 to drive the lift rack 306 towards the pick arm 300. The wedge 308 is to contact the cam follower 304 to lift the pick arm 300 off of the top of the stack 208. The pick arm 300 and the lift rack 306 may then be returned to a home or default state.

The contact of the wedge 308 and the cam follower 304 causes resistance, and hence the controller 206 may control the motor to exert more torque to continue to drive the lift rack 306 when the cam follower 304 and the wedge 308 meet. Further, based on the geometry of the wedge 308 and the pick arm 300, the cam follower 304 contacts the wedge 308 at different points along the wedge 308 based on the height of the stack 208. As can be seen, in FIG. 3A, the cam follower 304 will contact the wedge 308 at a first point 312 when the lift rack 306 is driven, while in FIG. 3B, the cam follower will contact the wedge 308 at a second point 314 when the lift rack 306 is driven.

Accordingly, the change in torque used to drive the lift rack 306 may be used to identify the position at which the cam follower 304 contacts the wedge 308. For example, based on the known speed at which the lift rack 306 is driven, the controller 206 may compute a position at which the cam follower 304 contacts the wedge 308 based on the position of the lift rack 306 when the motor 310 applies its peak torque. Additionally, the position at which the cam follower 304 contacts the wedge 308 may be used to estimate the height of the stack 208. The peak torque position may therefore be used as a picker metric and mapped as a function of the height of the stack 208 or the number of media sheets remaining in the stack 208. For example, the peak torque position and the height of the stack 208 are correlated by a predetermined linear relationship. This predetermined relationship may define a default model for the media level model, as well as providing a reference point to compare the regression to.

The controller 206 may measure the current picker metric once per print job, for example upon picking the first media sheet of the print job. In other examples, the controller 206 may measure the current picker metric for each media sheet picked during the print job.

The controller 206 may then use the picker metric to estimate the media level or the number of sheets remaining in the stack 208. To do so, the controller 206 is to add the current picker metric to a historical data set, apply a linear regression to the historical data set to obtain a media level model, and estimate a number of sheets remaining in the stack 208 based on the current picker metric and the media level model. In some examples, the controller 206 may further provide a notification or warning to a user based on the estimated number of sheets remaining in the stack 208.

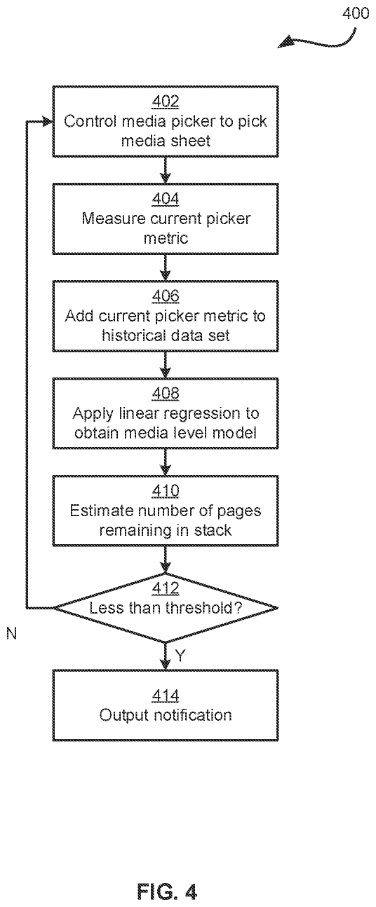

For example, referring to FIG. 4, an example method 400 of estimating the number of sheets remaining in the stack. The method 400 will be described in conjunction with its performance in the printer 200, and in particular by the controller 206. In other examples, the method 400 may be performed in other suitable systems.

The method 400 begins at block 402, for example, in response to the controller 206 receiving a print job to be executed by the printer 200. The print job may specify a number of sheets to be used, as well as other relevant information to execute the print job. In response to the print job, the controller 206 controls the media picker 204 to pick the media sheets from the stack 208 for the print job, in accordance with the print job parameters. For example, the controller 206 may actuate the motor 310 to drive the lift rack 306 to lift the pick arm 300.

At block 404, the controller 206 measures a current picker metric for the media picker 204. For example, the controller 206 may track the torque applied by the motor 310 to drive the lift rack 306 to lift the pick arm 300. More particularly, based on the geometry of the media picker 204, the controller 206 may identify a time at which the torque applied by the motor 310 is increased to identify the point at which the wedge 308 contacts the cam follower 304.

In some examples, the controller 206 may measure the picker metric once per print job (e.g., the torque applied when picking the first media sheet of the print job), while in other examples, the controller 206 may measure the picker metric once per media sheet picked.

At block 406, the controller 206 adds the current picker metric to a historical data set. The historical data set tracks the picker metrics measured at each print job. For example, the historical data set may additionally track a number of sheets used for each print job in association with the peak torque position for the print job. The historical data set may therefore associate the picker metric with a number of sheets remaining based on an initial number of media sheets in the stack 208. For example, Table 1 depicts an example historical data set.

TABLE 1
Historical Data Set

| Job | Picker Metric (Peak Torque | Number of | Sheets |
|---|---|---|---|
| ID | Position - encoder units) | Sheets Used | remaining |
| — | — | — | N |
| 1 | 1000 | 3 | N − 3 |
| 2 | 1050 | 2 | N − 5 |
| 3 | 1060 | 6 | N − 11 |

At block 408, the controller 206 applies a linear regression to the historical data set to obtain a media level model. That is, the media level model may be a line which best fits the historical data set. For example, the linear regression may employ a method of least squares, a least absolute deviation method Bayesian methods, or other suitable methods to obtain a line of best fit.

In some examples applying the linear regression to the historical data set may also include removing outliers from the historical data set to obtain a line of best fit which better models the historical data set. For example, the controller 206 may compute an R-squared value for each point in the data set to determine its fit to the line of best fit. The controller 206 may set a threshold R-squared value to keep the data set or discard it as an outlier. In other examples, the threshold may be a percentage within which data points are kept, and outside of which, data points are discarded as outliers. In other examples, other suitable methods of removing outliers are also contemplated.

At block 410, the controller 206 uses the media level model to estimate a number of sheets remaining in the stack 208.

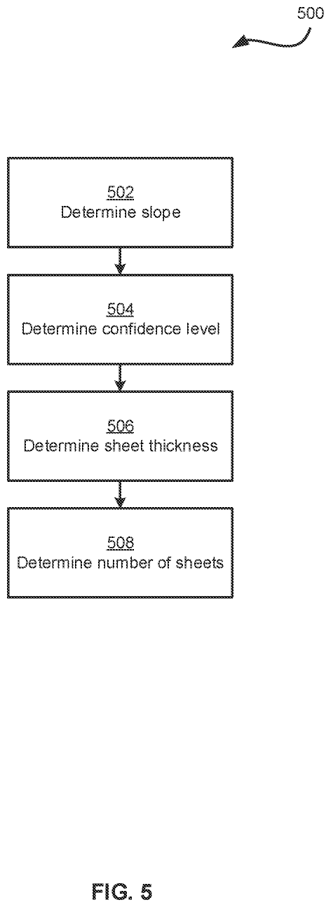

For example, referring to FIG. 5, an example method 500 of updating the media level model and estimating the number of media sheets remaining in the stack based on the linear regression is described in further detail.

At block 502, after applying the linear regression, the controller 206 obtains a line defining the media level model. In particular, the line may be the line of best fit—i.e., the line which best represents the historical data set. As part of the application of the linear regression controller 206 may determine a slope of the line. The slope of the line represents a ratio of the change in the picker metric to the change in the number of sheets remaining in the stack 208 (i.e., the number of sheets used). For example, when the regression is computed using least squares, the slope may be computed according to

### Equation 1

$$m = \frac{N \sum ( xy ) - \sum x \sum y}{N \sum {x}^{2} - {( \sum x )}^{2}} \qquad ( 1 )$$

In Equation 1, m is the slope of the line of best fit, representing the metric count per page, N is the size of the historical data set, x is the number of pages picked (or other suitable media level value, as appropriate), and y is the picker metric

Additionally, the controller 206 may compute the y-intercept b, according to Equation 2

$$b = \sum y \sum {x}^{2} - \sum x \sum xy \qquad ( 2 )$$

As will be appreciated, the slope of the line of best fit may change based on the data points collected in the historical data set. In other words, as the printer 200 executes more print jobs, additional picker metrics will allow the linear regression to more accurately represent the media level. Accordingly, the slope is not limited to a predefined relationship between the picker metric and the height of the stack 208, but rather is dynamically updated according to actual usage data.

At block 504, the controller 206 determines a confidence level in the proposed updated model (i.e., the line of best fit, or other output from the regression analysis) and uses the confidence level to determine whether or not to update the media level model. For example, the controller 206 may compare the R-squared value for the line of best fit to a predetermined threshold. If the R-squared value is above the predetermined threshold, the media level model may be updated using the output of the regression analysis. If the R-squared value is not above the predetermined threshold, the controller 206 may maintain the existing media level model.

At block 506, the controller 206 may optionally additionally determine the thickness of each media sheet. In particular, the picker metric is proportional to the height of the stack 208 in accordance with the predetermined linear relationship, and the thickness of each sheet can be computed based on the change in height over the number of sheets. Accordingly, the slope of the line may be used to compute a change in the picker metric between two points on the line, and therefore a change in height, as well as a number of sheets used between the same two points. Since the slope of the line is updated dynamically, the thickness of each media sheet is also dynamically computed. The printer 200 can therefore accommodate and more accurately predict media levels, even when the type of media is changed.

At block 508, the controller 206 determines the number of sheets remaining in the stack 208 based on the current picker metric and the media level model. In particular, since the media level model maps the picker metric as a function of the number of sheets remaining in the stack 208, an inverse application of the media level model may provide the estimated number of sheets remaining in the stack 208. In other words, based on the current picker metric, and the slope of the linear model, the controller 206 may determine the height of the stack 208. More particularly, based on equations (1) and (2), the solutions for m and b may be used to compute the picker metric y for any theoretical pages picked count (or other media level value). The difference between the computed picker metric y for the current number of pages picked and the calibrated empty stack picker metric y may be divided by m to obtain the number of pages remaining.

In other examples, the controller 206 may use the thickness of each media sheet to assist in or confirm how many sheets are remaining in the stack 208 of the computed height.

Returning to FIG. 4, at block 412, the controller 206 determines whether the number of sheets remaining in the stack 208 is less than a threshold number of sheets. The threshold number of sheets may be, for example, 5 sheets, 10 sheets, or any other suitable predefined number of sheets. If the determination at block 412 is negative, and the stack 208 still includes at least the threshold number of sheets, the controller 206 awaits the next print job and returns to block 402.

If the determination at block 412 is affirmative, and the stack 208 includes fewer than the threshold number of sheets, the controller 206 proceeds to block 414. At block 414, the controller 206 outputs a notification from the printer 200. For example, the controller 206 may control an output device, such as a speaker or a screen to emit a warning that the media tray is low on media for a user to refill. The warning may be an audio notification, such as a beep, an audio message, or the like, a visual notification, such as a text message displayed on a screen, a visual indicator, such as an icon or a warning light, or the like. In still further examples, the notification may be an email sent to a predetermined account, a text message, or the like.

As described above, an example printer may employ regressions to more accurately and dynamically update a media level model to estimate the media level in its media tray. In particular, by tracking picker metrics in a historical data set, a regression may be applied to the historical data set to obtain a best-fitting function mapping the picker metric as a function of the media level, in accordance with actual usage data. By using actual usage data, the media level model may account for different types of media used, including media having different thicknesses and the like. Accordingly, the printer may estimate a height of the media stack in the media tray, as well as a number of sheets remaining in the media tray. When the number of sheets remaining in the media tray is below a threshold number of pages, the printer may warn a user that the media tray is low on media sheets.

The scope of the claims should not be limited by the above examples, but should be given the broadest interpretation consistent with the description as a whole.

1. A method for estimating a media level of a media stack in a printer, the method comprising:
storing a media level model correlating a picker metric of a media picker to pick media from the media stack to the media level;
measuring a current picker metric when the media picker picks the media from the media stack during a print job;
adding the current picker metric to a historical data set;
updating the media level model by generating a regression for the historical data set; and
based on the current picker metric and the updated media level model, estimating a current media level of the media stack.

2. The method of claim 1, wherein the regression comprises a linear regression to generate a linear model of the media level.

3. The method of claim 1, further comprising calibrating the media level model based on a predefined height for an empty media stack.

4. The method of claim 1, further comprising estimating a thickness of each media sheet in the media stack.

5. The method of claim 1, wherein the current media level comprises a number of media sheets remaining in the media stack.

6. The method of claim 1, further comprising, when the current media level of the media stack is below a threshold value, outputting a notification.

7. The method of claim 1, further comprising resetting the historical data set upon detecting that a media tray holding the media stack is opened.

8. A printer comprising:
a media tray to store a stack of media sheets for use in the printer;
a media picker to pick the media sheets from the stack; and
a controller interconnected with the media picker, the controller to:
control the media picker to pick the media sheets from the stack for a print job;
measure a current picker metric for the media picker;
add the current picker metric to a historical data set;
apply a linear regression to the historical data set to obtain a media level model; and
estimate a number of sheets remaining in the stack based on the current picker metric and the media level model.

9. The printer of claim 8, wherein the controller is to measure the current picker metric once per print job.

10. The printer of claim 8, wherein the controller is to measure the current picker metric for each media sheet picked during the print job.

11. The printer of claim 8, wherein to estimate the number of sheets remaining in the stack, the controller is to:
determine a slope of a line defining the media level model;
shift the line to align a y-intercept based on a predefined picker metric for an empty media stack;
determine a thickness of each media sheet in the stack; and
determine the number of sheets remaining in the stack based on the current picker metric and the thickness of each media sheet.

12. The printer of claim 8, wherein the controller is further to remove outliers from the historical data set prior to applying the linear regression.

13. The printer of claim 8, wherein the controller is to output a notification when the number of sheets remaining in the stack is less than a threshold number of sheets.

14. A printer comprising:
a media tray to store a stack of media sheets for use in the printer;
a media picker to pick a top sheet of the stack of media sheets, the media picker comprising:
a pick arm including a roller to contact the top sheet;
a cam follower extending from the pick arm; and
a lift rack including a wedge extending from the lift rack, wherein the wedge is to contact the cam follower to lift the pick arm to pick the top sheet;
a controller interconnected with the media picker, the controller to:
control a motor to drive the lift rack to pick the media sheets from the stack for a print job;
measure torque used to lift the pick arm and identify a peak torque position;
add the peak torque position to a historical data set;
apply a linear regression to the historical data set to obtain a media level model;
estimate a number of sheets remaining in the stack based on the peak torque position and the media level model; and
when the number of sheets remaining in the stack is less than a threshold number of sheets, output a notification.

15. The printer of claim 14, wherein the controller is further to track, in the historical data set, a number of sheets used for the print job in association with the peak torque position.
